(19) United States
(12) Patent Application Publication
(10) Pub. No.: US 2006/0232955 A1
(43) Pub. Date: Oct. 19, 2006

(54) Light source for a helmet visor

(76) Inventor: Michael Labine, Winnipeg (CA)

Correspondence Address: Ryan W. Dupuis;Ade & Company Inc., 1795 Henderson Highway, P.O. Box 28006, Winnipeg, MB, R2G 4E9, CA

(21) Appl. No.: 11/405,440

(22) Filed: Apr. 18, 2006

(30) Foreign Application Priority Data
Apr. 18, 2005 (CA) 2,503,167

(51) Int. Cl. F21V 21/084; F21V 11/00

(52) U.S. Cl. 362/105; 362/359

(57) ABSTRACT

The present invention relates to light source for being supported on a visor device which is pivotally supported on a helmet between open and closed positions. The visor device supports the light source thereon for pivotal movement with the visor device. The visor device comprises a visor member and a mounting mechanism for pivotally supporting the device on a helmet with existing mounts. A power supply selectively powers the light source. The light source is mounted on the lower edge of the visor member such that the light shines forward when the visor device is opened to expose the facial opening of the helmet. Preferably, the light source is a strip of LED lights powered by a battery pack provided with a control mechanism for turning the lights on and off as well as adjusting their intensity. The light source may be pivotal relative to the visor member.

The present invention relates to a light source for being supported on a visor of a helmet, and more particularly relates to a visor which is pivotally supported on a helmet between open and closed positions and which supports the light source thereon for pivotal movement with the visor.

### BACKGROUND

Due to a high level of safety concerns for drivers and passengers of unenclosed vehicles such as motorcycles, snowmobiles and all terrain vehicles, a variety of types and styles of helmets are available to prevent injury in case of an accident. Due to the limited size and cargo capacity of such vehicles, it is often not possible to carry appropriate emergency equipment that would prove useful in the event of an accident or vehicle breakdown. One valuable piece of emergency equipment is a flashlight or other mobile light source, especially when participating in activities such as snowmobiling, where the vehicle is often used to travel to isolated remote locations in cold and often hostile weather conditions. Drivers and passengers can become stranded in the dark in an isolated area where help cannot be easily found. Without a light source it is difficult to inspect or repair a broken down vehicle and is easy to become lost, disoriented or injured when travelling in the dark.

U.S. Pat. No. 4,195,328 (Harris, Jr.) describes a lighting system for an unenclosed vehicle featuring a main headlight attached to the vehicle and an auxiliary headlight detachably mounted to the rider's helmet. While intended for use a headlight during night driving, the auxiliary headlight could also prove useful in an emergency situation. However, the power supply for both the main and auxiliary headlights is carried by the vehicle and operated by a switch thereon, limiting the range of use of the auxiliary light. Also, in the case of an accident or breakdown the power supply may be unusable.

U.S. Pat. No. 5,408,393 (Becker) describes a U-shaped head lamp assembly for use on protective headgear typically used by public safety or rescue personnel. The assembly, attached to a helmet through the use of spring clips, is shaped as so not to interfere with the use of a face shield. The assembly requires installation of the clips or other mounting devices on the helmet, and while removable, the assembly remains in a fixed position relative to the helmet when installed.

U.S. Pat. No. 5,564,128 (Richardson) provides an electroluminescent lamp strip for mounting on a safety helmet or attached face shield for use by by public safety or rescue personnel. The lamp strip is intended to be visible by third parties as a positional indicator of the wearer in hostile conditions and is not suitable for illuminating the surroundings of the wearer.

U.S. Pat. No. 5,743,621 (Mantha et al.) outlines an illuminated safety helmet for use during bicycling or other recreational activities. The helmet includes a pair of LED modules mounted on the front and rear of the helmet in order to indicate the position of the wearer to other parties in the dark. The invention is not intended to illuminate the surroundings of the wearer.

U.S. Pat. No. 6,721,962 (Polaire) describes a lighting system for a traditional baseball style hat without significantly altering its appearance. A low profile light is built into the brim of hat which means that the position of the light source relative to the hat is not adjustable. Also, the lighting system can not be easily retrofitted to an existing hat.

### SUMMARY

According a first aspect of the present invention there is provided a light source device in combination with a helmet, the helmet comprising:

an exterior shell;

a visor member substantially comprising transparent material and having a perimeter defined by an upper edge, a lower edge and two side edges;

a mounting mechanism for pivotally supporting the visor member on the exterior shell of the helmet;

the light source device comprising:

a light source supported on at least the lower edge of the perimeter of the visor member; and

a power supply for selectively supplying power to the light source.

According to another aspect of the present invention there is provided a replacement visor device for a helmet, the helmet comprising an exterior shell and a mounting mechanism for pivotally supporting the visor device on the exterior shell of the helmet, the visor device comprising:

a visor member substantially comprising transparent material and having a perimeter defined by an upper edge, a lower edge and two side edges;

a light source integrally supported on at least the lower edge of the perimeter of the visor member; and

a power supply for selectively supplying power to the light source.

According to another aspect of the present invention there is provided a visor device for a helmet, the visor device comprising:

a visor member substantially comprising transparent material and having a perimeter defined by an upper edge, a lower edge and two side edges;

a mounting mechanism for pivotally supporting the visor member on the helmet;

a light source supported on at least the lower edge of the perimeter of the visor member; and

a power supply for selectively supplying power to the light source.

The invention provides a portable lighting solution for operators and passengers of unenclosed vehicles. Once the invention has been installed on a user's helmet, there is no longer a need to carry a separate light source for emergency situations. The visor device can be easily installed on a typical helmet with existing mounts for a visor. By providing the invention as an add-on for existing helmets, the cost for the user can be kept to a minimum. The invention can also be provided as part of a full helmet device for those to who are looking to replace an old helmet and like the added safety associated with the built-in light source.

The present invention also provides an advantage over the prior art by allowing the position of the light source to be changed with respect to the helmet. Mounting the light source on the bottom edge of the visor device allows the path of light to be changed with respect to the helmet simply by pivoting the device about the mounting mechanism.

According to a further aspect of the present invention there is provided a helmet device comprising:

an exterior shell with a facial opening;

a visor member substantially comprising transparent material and having a perimeter defined by an upper edge, a lower edge and two side edges;

a mounting mechanism for pivotally supporting the visor member on the shell for movement between an open position in which the visor member substantially blocks the facial opening and a closed position in which the visor member does not substantially block the facial opening;

a light source supported on at least the lower edge of the perimeter of the visor member; and

a power supply for selectively supplying power to the light source.

The light source preferably comprises light emitting diodes which are illuminated at a pulsed rate of at least 30 cycles per second.

When the power supply comprises a battery pack containing at least one battery, the power supply may be supported on a fixed portion of the pivotal mounting mechanism which is fixedly mounted on the exterior shell of the helmet.

When there is provided a control mechanism for selectively controlling the supply of electricity from the power supply to the light source, the control mechanism is preferably also supported on the fixed portion of the pivotal mounting mechanism.

Alternatively, the control mechanism may be supported on the visor member.

In either instance, the control mechanism preferably comprises a mechanism for adjusting the intensity of the light source.

When the mounting mechanism pivotally supports the visor member on the helmet for movement between a closed position in which the visor member substantially blocks a facial opening at the front of the helmet and an open position in which the visor member does not substantially block the facial opening, the light source is preferably oriented such that light projects generally parallel to a front surface of the visor member and the light source is pivotal with the visor member relative to the exterior shell of the helmet. Accordingly, the light source is preferably oriented such that light projects generally downward when the visor member is in the closed position and forward when the visor member is in the open position.

When the light source is pivotally supported on the visor member, the light may also be projected forwardly in the closed position of the visor member. The light source is preferably pivotal relative to the visor member about a generally horizontal axis extending laterally between opposing sides of the exterior shell, however in alternate embodiments, the light source may be pivotal relative to the visor member about compound axes for pivoting both up and down as well as side to side.

When the light source is pivotal generally upward and downward relative to the visor member in the closed position, the light source is preferably pivotal through a range including a first position projecting downwardly and generally parallel to the visor member and a second position projecting forwardly and generally perpendicularly to the visor member.

When the visor member comprises a pane of substantially transparent material having a rim member extending along at least a lower edge portion of the pane, the light source may be supported on the rim member.

The light source may comprise a first source supported on the lower edge of the visor member and a second source supported on an upper edge of the visor member. In the closed position of the visor member, the first source may be oriented to project light downwardly and generally parallel to the visor member or forwardly and generally perpendicular to the visor member while the second source projects light forwardly and generally parallel to the visor member.

When the power supply is selectively supported on the helmet for selective separation from the helmet, there may be provided a secondary light source coupled to the power supply for selective separation from the helmet with the power supply in which the secondary light source also receives power for illumination from the power supply.

There may be provided a control mechanism arranged to selectively operate the light source on the visor and the secondary light source independently of one another.

According to another aspect of the present invention there is provided a method of providing a light source on a helmet comprising an exterior shell with a facial opening and an existing visor supported on existing mounts, the method including:

providing a replacement visor device comprising:
a visor member substantially comprising transparent material and having a perimeter defined by an upper edge, a lower edge and two side edges;

a mounting mechanism for pivotally supporting the visor member on the existing mounts;

a light source supported on at least the lower edge of the perimeter of the visor member; and

a power supply for selectively supplying power to the light source; removing the existing visor from the helmet; and

mounting the replacement visor device on the existing mounts of the helmet.

Preferably the method includes orienting and positioning the light source with respect to the helmet by pivoting the visor member about the mounting mechanism.

Preferably the method includes providing a control mechanism for controlling the supply of electricity from the power supply to the light source.

Preferably the method includes turning the light source on or off using the control mechanism.

Preferably the method includes adjusting the intensity of the light source using the control mechanism.

Preferably the method includes supporting the light source also on the upper edge of the perimeter of the visor member such that light from the upper edge is projected in a direction generally perpendicular to light from the lower edge.

### BRIEF DESCRIPTION OF THE DRAWINGS

In the accompanying drawings, which illustrate exemplary embodiments of the present invention:

FIG. 1 is a side view of an example of a typical helmet for which the present invention is intended.

FIG. 2 is a side view of a first embodiment of the present invention installed on a first type of helmet in a closed position.

FIG. 3 is a side view of the first embodiment of the present invention installed on the first type of helmet in an open position.

FIG. 4 is a front view of the first embodiment of the present invention installed on the first type of helmet in a closed position.

FIG. 5 is a side view of a second embodiment of the present invention installed on a second type of helmet in a closed position.

FIG. 6 is a front view of the second embodiment of the present invention installed on the second type of helmet in an open position.

FIG. 7 is a front view of the second embodiment of the present invention installed on the second type of helmet in a closed position.

FIG. 8 is a side view of a third embodiment of the present invention installed on a third type of helmet in an open position.

FIG. 9, is a front view of the third embodiment of the present invention installed on the third type of helmet in an open position.

FIG. 10 is a front view of the third embodiment of the present invention installed on the third type of helmet in a closed position.

FIG. 11 is a cross sectional view of a further embodiment of the present invention installed on the first type of helmet in an open position.

FIG. 12 is a side elevational view of yet a further embodiment of the present invention.

FIG. 13 is an enlarged side elevational view of the light source which can be used in any of the above noted embodiments.

### DETAILED DESCRIPTION

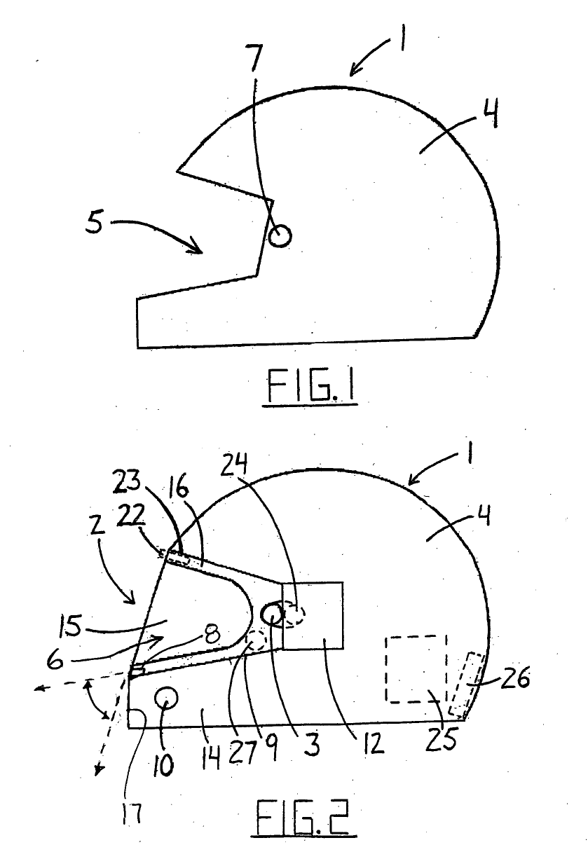

FIG. 1 illustrates an example of a helmet 1 on which the present invention can be installed. The helmet 1 includes an exterior shell 4 to fit around the head of the user, a facial opening 5 in the front to allow the user to see out of the helmet and mounts 7 on either side for supporting a visor.

In reference to FIGS. 2, 5 and 8, the common features of the various embodiments of the present invention will now be described in which a side view of a helmet 1 and corresponding visor device is shown. The visor device 2 includes a visor member 6 and mounting mechanisms 3 for pivotally mounting the device on mounts 7. The invention provides a power supply 12 and a control mechanism 10 for selectively providing power to a light source 8. The light source 8 is mounted along a portion of the bottom edge 9 of the visor member 6. The light source can be adjusted, but in the preferred configuration the light emitted from the light source shines forward, generally parallel to a front surface of the visor member when the visor device 2 is in an open position and the light source shines downward, also generally parallel to the visor member, when the visor device 2 is in a closed position. Orientation of the light source is thus pivoted with the visor member relative to the helmet while orientation relative to the visor member remains fixed.

The closed and open positions of the visor device are first illustrated in FIGS. 2 and 3 respectively. The facial opening 5 is completely covered by the visor member 6, which spans generally downwardly across the opening in the closed position. The facial opening is generally unobstructed in the open position when the visor member projects outwardly from the helmet, transversely to the plane of the opening.

In the illustrated embodiment, the light source 8 comprises a strip of LED (light emitting diode) lights and the power supply 12 comprises a battery pack. LED lights are very energy efficient and therefore are capable of providing light for long periods of time on small energy sources. To further extend battery life, the LED lights are illuminated at a pulsed rate of at least 30 cycles per second, and more preferably near 60 cycles per second as this rate is found to appear as constant illumination to a user while minimizing energy required to maintain the LED lights in an illuminated condition. As a result, the power supply 12 can be kept accordingly small and lightweight. The control mechanism 10 provides capability for the user to turn the light source 8 on and off as well as control its intensity.

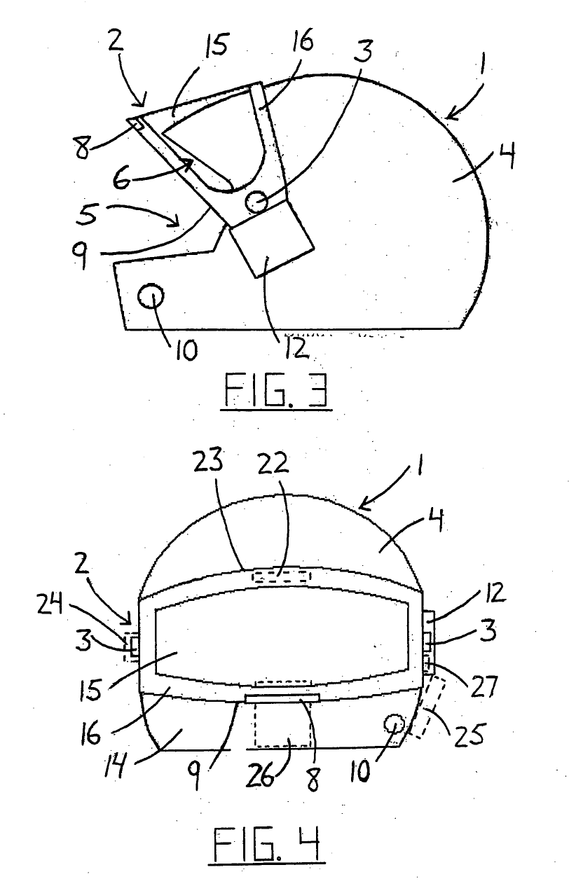

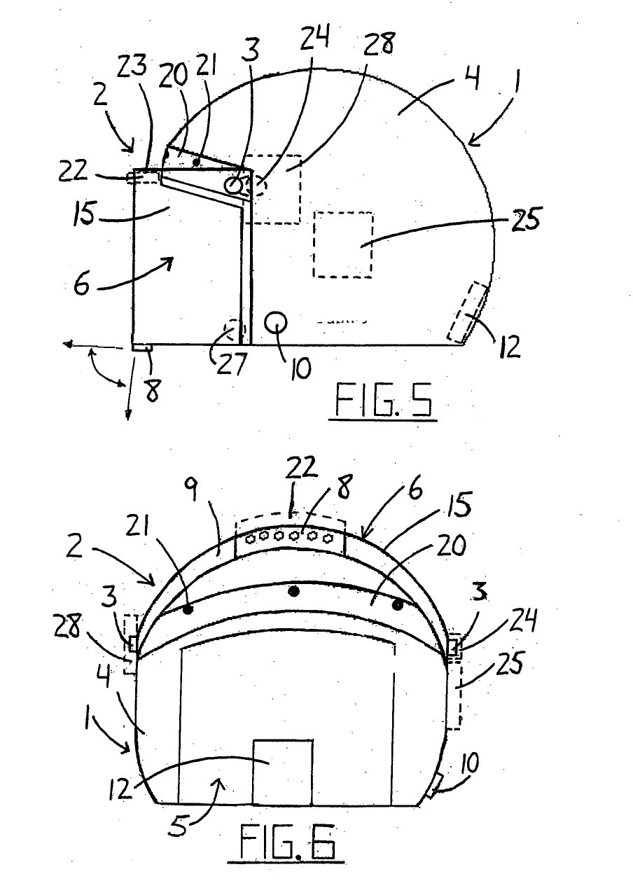

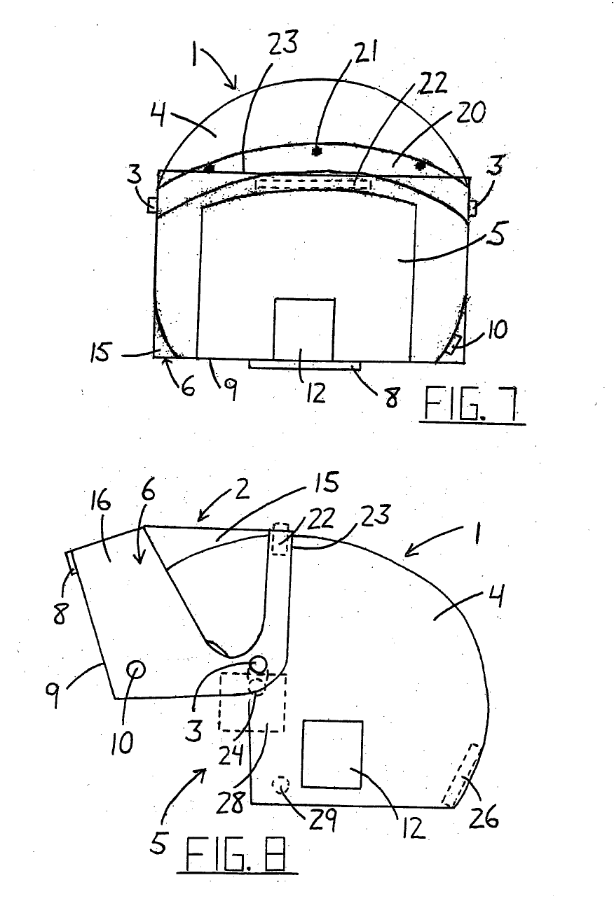

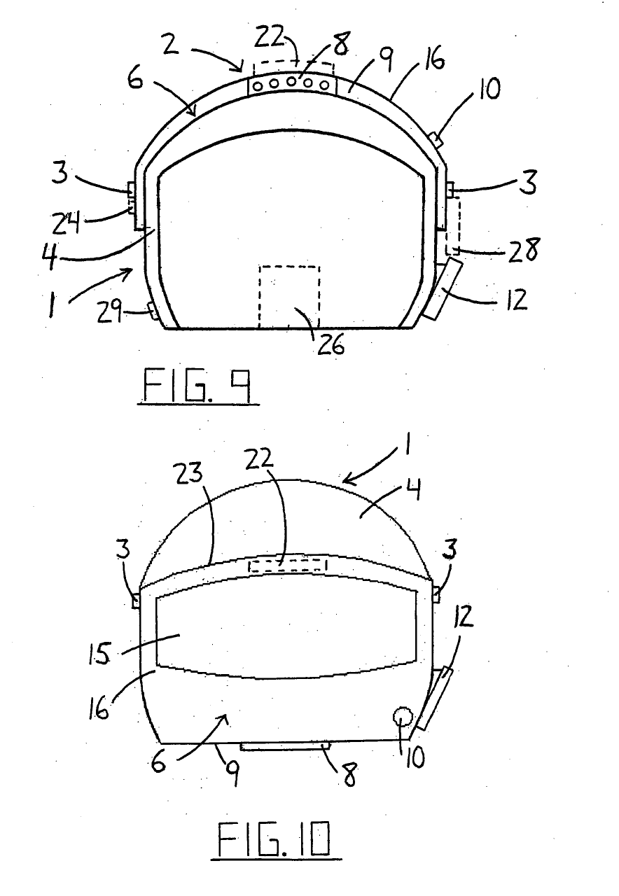

A first embodiment is shown in FIGS. 2-4 on a helmet that features a lower portion 14 extending forward beneath the visor member 6. Here the visor member 6 comprises a pane 15 of transparent material surrounded and supported by a rim 16. The mounting mechanisms 3 are mounted on the rim 16 and pivotally connect the entire visor member 6 to the helmet mounts 7. The light source 8 is mounted in a recessed portion of the bottom edge 9 of the visor member 6, which in this case corresponds to the bottom edge of the rim 16. Mounting the light source 8 this way prevents it from protruding beyond the bottom edge 9, helping retain the appearance of a standard visor and also ensures that the visor device 2 and lower portion 14 fit firmly together when the visor device is in a closed position as seen in FIGS. 2 and 4. As a result, there is no need to modify the helmet 1 to accommodate the light source 8 or significantly alter the shape of the visor device 2 from that of a standard visor to ensure a proper fit. In this embodiment, the battery pack power supply 12 is supported on the mounting mechanism 3 of the visor device 2 and the control mechanism 10 is mounted on the exterior shell 4 of the helmet on the lower portion 14.

A second embodiment for use with a different style of helmet is shown in FIGS. 5-7. The type of helmet illustrated here does not feature mounts on the side or a lower portion like the helmet in the previous embodiment. Instead, the helmet has mounts spaced along the front of the helmet above the facial opening 5 which extends right to the bottom of the exterior shell 4. The visor device 2 comprises a visor member 6 and a top support member 20 that includes mounting mechanisms 21 for rigidly attaching to the helmet mounts. The visor member 6 is pivotally attached to either end of the support member 20 by pivotal mounting mechanisms 3. Once again, the light source 8 is mounted on a bottom edge 9 of the visor member 6. The visor member here comprises a transparent pane 15 of appropriate size to cover the facial opening 5. Since the pane 15 is not surrounded by a rim in this embodiment, the light source 8 is mounted on the bottom edge of the pane 15. As a result of the larger visor member 6 to cover the larger facial opening 5, the light source 8 is positioned lower than in the previous embodiment when the visor device 2 is in the closed position illustrated in FIGS. 5 and 7, but is at approximately the same height when shining forward in the open position illustrated in FIG. 6. The power supply 12 is shown mounted inside the exterior shell 4 at the rear of the helmet opposite the facial opening and the control mechanism 10 is supported on the outside of the exterior shell 4.

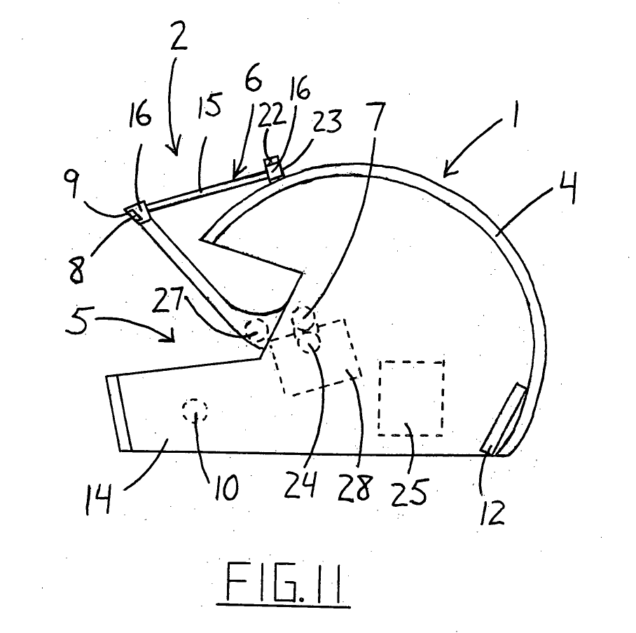

A third embodiment is shown in FIGS. 8-10 on another style of helmet. The exterior shell 4 on this type of helmet has no lower portion beneath the facial opening 5 like the helmet in FIG. 1, but does include the mounts 7 on the side. The large facial opening 5 due to the lack of a lower portion 14 designates a need for a large visor member 6. The visor member 6 in this case includes a rim 16 and a transparent pane 15 as in the first embodiment, but the portion of the rim 16 below the pane 15 extends down to the bottom of the exterior shell 4 of the helmet in order to cover the larger facial opening 5. The mounting mechanism 3 pivotally connects the rim 16 and supported pane 15 to the helmet mounts 7. The light source 8 is mounted to the bottom edge 9 of the visor member 6, which in this case corresponds to the bottom edge of the portion of the rim 16 below the pane 15. As in the second embodiment, the light source 8 is positioned lower than in the first embodiment when the visor device 2 is in the closed position illustrated in FIG. 10, but is at approximately the same height when shining forward in the open position illustrated in FIGS. 8 and 9. In this embodiment, the power supply 12 is mounted on the exterior shell 4 of the helmet and the control mechanism 10 is mounted on the rim 16 of the visor member 6 below the pane 15.

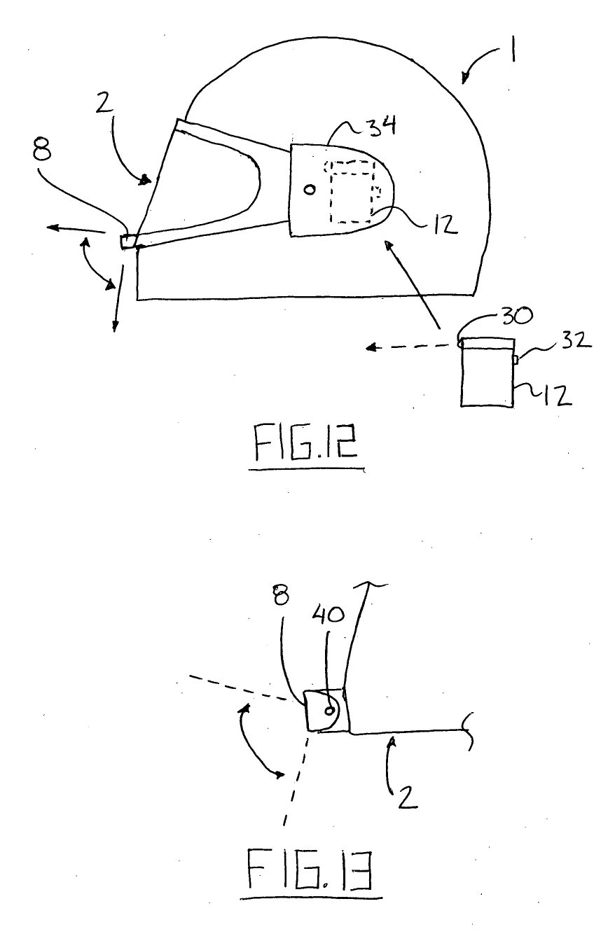

As shown in FIG. 12, the power supply 12 for any of the above noted embodiments may comprise a battery pack which is enclosed within its own housing that is selectively supported on the exterior shell or on the pivotal mounting mechanism of the helmet. In the illustrated embodiment, the light source is mounted on a fixed cover member 34 of the pivotal mounting mechanism which spans over and covers the hinge supporting the visor member on the exterior shell.

A secondary light source 30 is integrally mounted on the housing of the power supply for selective separation of the secondary light source from the helmet with the power supply housing. Both the light source 8 on the visor member and the secondary light source 30 receive power from the power supply 12, however each is provided with its own independent control mechanism to selectively illuminate the light source in a preferred embodiment. Accordingly a control mechanism 32 is provided on the power supply housing for separation with the power supply and secondary light source 30 to control the secondary light source similarly to a portable flashlight when separated from the helmet.

The secondary light source 30 is oriented to project forwardly, generally perpendicularly to the plane of the visor opening in the helmet when the power supply is supported on the helmet. Accordingly in further embodiments there may be provided a common control mechanism which operates both light sources together when the power supply is supported on the helmet.

In the embodiments described thus far, the light source 8 has always been mounted on the bottom edge 9 of the visor member 6, regardless of whether the bottom edge 9 corresponds to a bottom edge of the pane 15 in a rimless visor member or the bottom edge of the rim 16 in a rimmed visor member. While the light source 8 could conceivably be supported on the pane 15 in both cases, it is preferred that the light source is mounted on the rim 16 when one is present in order to prevent the light source from obstructing the view of the helmet wearer through the transparent pane and to prevent the path of light from being even partially blocked by the rim. Also, while the light source 8 was embedded in a recessed portion of the rim 16 in the first embodiment but not in the third, it is possible to do so in all cases where a rim is present should it be considered desirable to keep the light source out of view. However, since the bottom edge 9 of the visor member 6 in the third embodiment does not come into contact a lower portion 14 of the helmet, flush mounting the light source 8 with the lower surface of bottom edge 9 isn't considered necessary.

The three embodiments already described not only feature different visor device styles for different helmet types, but also feature different mounting positions for the power supply 12 and the control mechanism 10. Further embodiments of the present invention are possible by mixing aspects of those already described. FIGS. 2, 4, 5, 6, 8, 9 and 11 show alternate mounting positions for the power supply and control mechanism indicated by dashed lines. The power supply 12 can be supported on the mounting mechanism 3 of the visor device 2 as indicated by 28, on the exterior shell 4 of the helmet 1 as indicated by 25, or inside the exterior shell 4 as indicated by 26. The control mechanism 10 can be supported on the mounting mechanism 3 of the visor device 2 as indicated by 24, on the visor member as indicated by 27, or on the exterior shell 4 of the helmet 1 as indicated by 29.

Even further embodiments may have the light source supported in additional locations besides the lower edge 9 of the visor member 6. For example, FIG. 11 shows a cross section of a helmet 1 and visor device 2 similar to those of the first embodiment. The changes in this instance include having the power supply 12 supported inside the exterior shell 4 and having a second strip of LED lights 22 mounted along an upper edge 23 of the visor member 6, which in this case corresponds to an upper edge of the rim 16. The second strip 22 is mounted such that the light will shine forward when the visor device 2 is in the closed position so that the beam of light is generally perpendicular and directed outwardly in relation to the visor member. This feature adds flexibility to the invention by making it possible to shine light in multiple directions at once. FIGS. 2, 4, 5, 6, 8 and 9 show possible mounting positions for such an addition to the first three embodiments by dashed lines indicated at 22.

The present invention can be manufactured as a visor device alone for marketing as an add-on or replacement visor for existing helmets or as a part of a package wherein a visor device and helmet are sold together, whether already assembled or not. Furthermore, the light source may be provided as an auxiliary attachment for a helmet visor. In the case where the invention is marketed as a replacement visor for an existing helmet and visor combination, the product is installed by removing the existing visor and mounting the replacement visor device 2 in its place on the helmet 1.

In all embodiments, a light source 8 is provided which can be mounted on a helmet for pivotal movement with the visor member to vary the orientation and direction of a beam of light emitted by the light source. As shown in the enlarged view of the light source 8 in FIG. 13, the light source includes a hinge 30 which allows pivotal movement of the light source relative to the visor device upon which it is supported about a generally horizontal axis oriented in a lateral direction extending between opposing sides of the helmet. In a variation of the illustrated embodiment, the hinge may comprise a ball and socket joint or a compound hinge, either of which would allow pivotal movement of the light source 8 in both an up and down direction or a side to side direction.

When the visor member extends generally downward across the helmet opening in the closed position, the light source is pivotal relative to the helmet such that the beam of light may be varied from a downward direction parallel to the visor member and the plane of the helmet opening to an outward direction which is generally perpendicular to the visor member and the plane of the helmet opening. When the visor member is in the open position to extend outward from the helmet generally perpendicular to the plane of the helmet opening, the range of directions of the light from the light source is varied due to the light source being pivotal with the visor member. Accordingly, in the open position, the light beam is varied by pivotal movement of the light source relative to the visor member from an upward direction generally perpendicular to the visor member to an outward direction extending forwardly and generally parallel to the visor member.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A light source device in combination with a helmet, the helmet comprising:
an exterior shell;
a visor member substantially comprising transparent material and having a perimeter defined by an upper edge, a lower edge and two side edges;
a mounting mechanism for pivotally supporting the visor member on the exterior shell of the helmet;
the light source device comprising:
a light source supported on at least the lower edge of the perimeter of the visor member; and
a power supply for selectively supplying power to the light source.

2. The device according to claim 1 wherein the light source comprises light emitting diodes.

3. The device according to claim 2 wherein the light emitting diodes are illuminated at a pulsed rate of at least 30 cycles per second.

4. The device according to claim 1 wherein the power supply comprises a battery pack containing at least one battery.

5. The device according to claim 1 wherein the power supply is supported on a fixed portion of the pivotal mounting mechanism which is fixedly mounted on the exterior shell of the helmet.

6. The device according to claim 1 wherein there is provided a control mechanism for selectively controlling the supply of electricity from the power supply to the light source.

7. The device according to claim 6 wherein the control mechanism is supported on a fixed portion of the pivotal mounting mechanism which is fixedly mounted on the exterior shell of the helmet.

8. The device according to claim 6 wherein the control mechanism is supported on the visor member.

9. The device according to claim 6 wherein the control mechanism comprises a mechanism for adjusting the intensity of the light source.

10. The device according to claim 1 wherein the mounting mechanism pivotally supports the visor member on the helmet for movement between a closed position in which the visor member substantially blocks a facial opening at the front of the helmet and an open position in which the visor member does not substantially block the facial opening, the light source being oriented such that light projects downward when the visor member is in the closed position and forward when the visor member is in the open position.

11. The device according to claim 1 wherein the mounting mechanism pivotally supports the visor member on the helmet for movement between a closed position in which the visor member substantially blocks a facial opening at the front of the helmet and an open position in which the visor member does not substantially block the facial opening, the light source being oriented such that light projects generally parallel to a front surface of the visor member and the light source is pivotal with the visor member relative to the exterior shell of the helmet.

12. The device according to claim 1 wherein the visor member comprises a pane of substantially transparent material having a rim member extending along at least a lower edge portion of the pane, the light source being supported on the rim member.

13. The device according to claim 1 wherein the light source comprises a first source supported on the lower edge of the visor member and a second source supported on an upper edge of the visor member.

14. The device according to claim 13 wherein in the closed position of the visor member the first source projects light downwardly and generally parallel to the visor member and the second source projects light forwardly and generally parallel to the visor member.

15. The device according to claim 1 wherein the light source is pivotally supported on the visor member.

16. The device according to claim 15 wherein the light source is pivotal relative to the visor member about a generally horizontal axis extending laterally between opposing sides of the exterior shell.

17. The device according to claim 15 wherein the light source is pivotal generally upward and downward relative to the visor member in the closed position through a range including a first position projecting downwardly and generally parallel to the visor member and a second position projecting forwardly and generally perpendicularly to the visor member.

18. The device according to claim 1 wherein the power supply is selectively supported on the helmet for selective separation from the helmet and wherein there is provided a secondary light source coupled to the power supply for selective separation from the helmet with the power supply, the secondary light source receiving power for illuminating the secondary light source from the power supply.

19. The device according to claim 18 wherein there is provided a control mechanism arranged to selectively operate the light source on the visor and the secondary light source independently of one another.

20. A replacement visor device for a helmet in which the helmet comprises an exterior shell and a mounting mechanism for pivotally supporting the visor device on the exterior shell of the helmet, the visor device comprising:
a visor member substantially comprising transparent material and having a perimeter defined by an upper edge, a lower edge and two side edges;
a light source integrally supported on at least the lower edge of the perimeter of the visor member; and
a power supply for selectively supplying power to the light source.
